(19) United States
(12) Patent Application Publication
(10) Pub. No.: US 2017/0034673 A1
(43) Pub. Date: Feb. 2, 2017

(54) METHOD AND APPARATUS FOR ENABLING PUSH-TO-TALK FUNCTIONALITY OF A MOBILE DEVICE

(71) Applicant: MOTOROLA SOLUTIONS, INC, SCHAUMBURG, IL (US)

(72) Inventors: CHUN KIT CHONG, KULIM (MY); WEE SIANG HUN, SUNGAI PETANI (MY); KHAI LOKE LIM, PENANG (MY); MUNISWARAN RAMACHANDRAN, GEORGETOWN (MY); TEIK SIN TAN, BUKIT MERTAJAM (MY)

(21) Appl. No.: 14/811,925

(22) Filed: Jul. 29, 2015

(51) Int. Cl. H04W 4/10; H04W 76/00; H04B 1/3827; H04L 29/06

(52) U.S. Cl. CPC H04W 4/10; H04L 65/4061; H04W 76/005; H04B 1/3833

(57) ABSTRACT

A method and mobile device are provided that permits hands-free enablement of Push-to-Talk (PTT) functionality. When the mobile device is being used by a user, the mobile device determines, via an eye detector of the mobile device, a presence of an eye of a user and detects, via a microphone of the mobile device, an audio input from the user. When the mobile device determines the presence of the eye of the user and determines that the detected audio input is greater than an audio intensity threshold, the mobile device enables the PTT functionality and transmits voice that is input to the mobile device by the user as part of a PTT communication session. Thus, the user may participate in a PTT communication and transmit voice communications notwithstanding an inability of the user to press a PTT button or key of the mobile device.

### FIELD OF THE INVENTION

The present invention relates generally to wireless communication systems, and more particularly, to enabling Push-to-Talk (PTT) functionality of a mobile device.

### BACKGROUND OF THE INVENTION

Situations exist where it may be difficult for a user to press a Push-to-Talk (PTT) button of a mobile device when engaging in a group communication. For example, a Land Mobile Radio (LMR) may be in a vehicular charger where access to the button is obscured, or the user may not have a free-hand to press the button.

### BRIEF DESCRIPTION OF SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless communication system in accordance with some embodiments of the present invention.

FIG. 2 is a block diagram of a mobile station of the communication system of FIG. 1 in accordance with some embodiments of the present invention.

FIG. 3 is a logic flow diagram illustrating a method executed by the mobile device of FIG. 1 in enabling Push-to-Talk functionality in accordance with some embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where volume differential specific meanings have otherwise been set forth herein.

### DETAILED DESCRIPTION OF THE INVENTION

A method and a mobile device are provided that permits hands-free enablement of Push-to-Talk (PTT) functionality. When the mobile device is being used by a user, the mobile device determines, via an eye detector of the mobile device, a presence of an eye of a user and detects, via a microphone of the mobile device, an audio input from the user. When the mobile device determines the presence of the eye of the user and determines that the detected audio input is greater than an audio intensity threshold, the mobile device enables the PTT functionality and transmits voice that is input to the mobile device by the user as part of a PTT communication session. Thus, the user may participate in a PTT communication and transmit voice communications notwithstanding an inability of the user to press a PTT button or key of the mobile device.

Generally, an embodiment of the present invention encompasses a method for enabling Push-to-Talk (PTT) functionality. The method includes detecting a presence of an eye of a user, detecting an audio input from the user, determining that the audio input is greater than an audio intensity threshold, and, in response to detecting the presence of the eye of the user and detecting the audio input greater than the audio intensity threshold, enabling PTT functionality.

Another embodiment of the present invention encompasses a mobile device comprising an eye detector, a microphone, a processor, and an at least one memory device. The at least one memory device is configured to store a set of instruction that, when executed by the processor, cause the processor to determine, via the eye detector, a presence of an eye of a user, detect, via the microphone, an audio input from the user, determine that the audio input is greater than an audio intensity threshold, and, in response to determining the presence of the eye of the user and determining that the audio input is greater than the audio intensity threshold, enable PTT functionality.

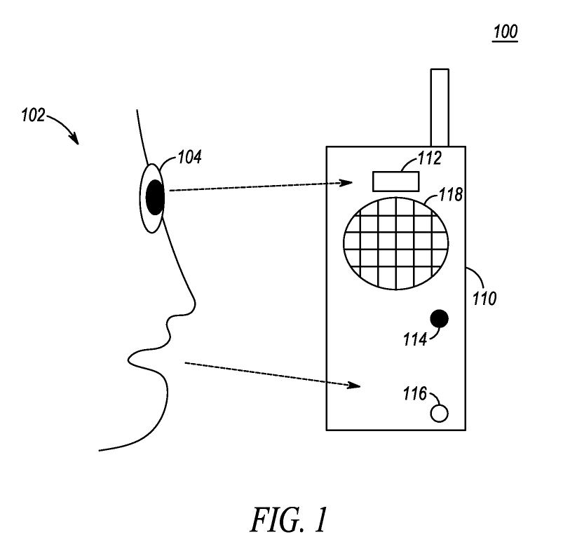

The present invention may be more fully described with reference to FIGS. 1-3. FIG. 1 is a block diagram of a wireless communication system 100 in accordance with some embodiments of the present invention. Communication system 100 includes a user 102 and the user's mobile device 110, such as but not limited to a cellular telephone, a smart phone, a two-way radio such as a land mobile radio (LMR), and so on. Mobile device 110 includes a user interface comprising multiple components for receiving information from, and providing information to, user 102, which user interface includes an eye detector 112, typically comprising a camera, that detects a presence of an eye 104 of user 102, a Push-to-Talk (PTT) indicator 114 that provides a visual or audio indication that the mobile device is ready to receive an audio input from user 102, a microphone 116 for receiving audio input from user 102, and a display screen 118.

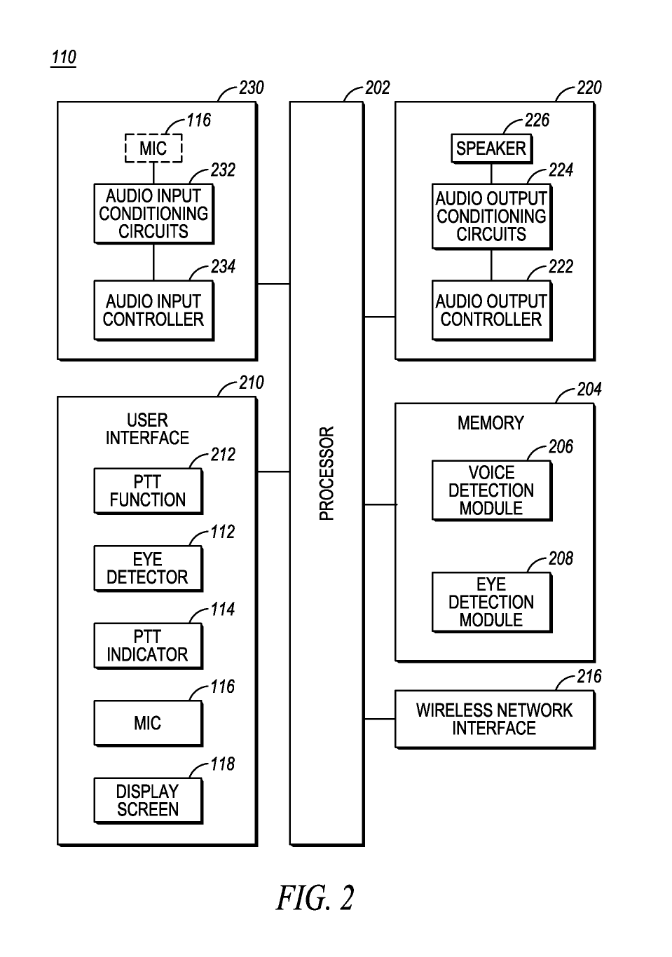

Referring now to FIG. 2, a block diagram is provided of mobile device 110 in accordance with some embodiments of the present invention. Mobile device 110 operates under the control of a processor 202, such as one or more microprocessors, microcontrollers, digital signal processors (DSPs), combinations thereof or such other devices known to those having ordinary skill in the art. Processor 202 operates mobile device 110 according to data and instructions stored in an at least one memory device 204, such as random access memory (RAM), dynamic random access memory (DRAM), and/or read only memory (ROM) or equivalents thereof, that stores data and programs that may be executed by processor 202 so that the mobile device may perform the functions described herein.

At least one memory device 204 includes a voice detection module 206 for detecting an audio input of user 102, determining a volume level of the audio input and any ambient noise, and associating a user with the audio input, that is, recognizing the user who sourced the audio input. For example, at least one memory device 204 may store voice patterns associated with each of one or more users, such as user 102, and processor 202 may associate a user with an audio input by matching a voice pattern determined for the audio input to a stored voice pattern in accordance with known voice recognition techniques. At least one memory device 204 further includes an eye detection module 208 for detecting a presence of, and a distance of, eye 104 of user 102. Further, eye detection module 208 may associate a user with the detected eye, such as user 102 with eye 104, based on user eye patterns stored by at least one memory device 204 and in accordance with known eye recognition techniques.

Mobile device 110 further includes one or more wireless network interfaces 216 (one shown) in communication with processor 202 and for wirelessly communicating with a wireless accessory, another mobile device, and/or a wireless access network. For example, the one or more wireless network interfaces 216 may include a radio frequency (RF) transceiver coupled to an antenna and for receipt and transmission of RF signals, which RF transceiver includes an RF receiver (not shown) for receiving RF signals from an access network serving the mobile device and an RF transmitter (not shown) for transmitting RF signals. By way of other examples, the one or more wireless network interfaces 216 may include a wireless network interface for directly communicating with another mobile device via a proximity-based wireless protocol, such as a Near Field Communication (NFC) or Bluetooth® protocol, and/or wireless network interface for communicating with other mobile devices and/or an access point (not shown) of communication system 100 via a short range protocol, for example, a local area network (LAN) protocol or, again, a Bluetooth® protocol. Processor 202 controls the operation of mobile device 110 and the one or more wireless interfaces 216, such as an exchange of RF signals with a wireless access network (not shown) and/or another mobile device or a vehicular modem (not shown).

Mobile device 110 also includes a user interface 210 that provides a user of the mobile device with a capability of interacting with the mobile device, including inputting instructions into the mobile device. For example, user interface 210 includes eye detector 112, PTT indicator 114, microphone 116, display screen 118, and a PTT function 212, such as a PTT key or a voice-enabled PTT trigger. A link between PTT function 212 and audio input circuitry 230 of the mobile device may be provided by processor 202 for initiating, and reserving a floor of, a PTT call and for enabling receipt of, and processing, voice from a user as part of a PTT communication session.

Audio input circuitry 230 allows a user to input audio signals into the mobile device. Audio input circuitry 230 includes microphone 116 coupled to audio input conditioning circuits 232, and an audio input controller 234 coupled to the audio input conditioning circuits. Microphone 116 allows a user to input audio signals into mobile device 110. User speech is received by microphone 116 and is converted into an electrical audio signal. Audio input conditioning circuits 232 receive the audio signal and perform various conditioning functions on the audio signal, for example, noise reduction. Audio input controller 234 receives the conditioned audio signal and sends a representation of the audio signal to processor 202, which then processes the signal for transmission via the one or more wireless interfaces 216. Audio input controller 234 further may calculate a signal strength, or energy level, of the received audio signal, may calculate a signal strength, or energy level, of background noise, and may provide the calculated signal strengths/energy levels to processor 202.

Mobile device 102 further includes audio output circuitry 220 for audio output for listening by a user of the mobile device. In an embodiment of the present invention, audio output circuitry 220 includes an audio output controller 222 coupled to audio output conditioning circuits 224 and a speaker 226 coupled to the audio output conditioning circuits. Audio output controller 222 receives decoded audio output signals from processor 202 and sends the received decoded audio signals to audio output conditioning circuits 224 that perform various conditioning functions. For example, the audio output conditioning circuits 224 may reduce noise or amplify the signal. Speaker 226 receives the conditioned audio signals and allows audio output for listening by a user. In various embodiments of the present invention, audio output controller 222 and audio input controller 234 each may be implemented by processor 202 based on data and instructions stored in an at least one memory device 204, or one or more of audio output controller 222 and audio input controller 234 may be implemented by a processor separate from, and coupled to, processor 202.

As described in greater detail below, in various embodiments of the present invention, voice detection module 206 and eye detection module 208 control an enablement of PTT functionality in mobile device 110. That is, when processor 202 determines, according to criteria described below, that user 102 is desirous of engaging a PTT communication session, the processor enables PTT functionality without requiring that the user press a PTT button or softkey. Processor 202 may determine that user 102 is desirous of engaging in a PTT communication based on one or more of a detection of user 102's eye 104 within a predetermined range of mobile device 110 and a detection of an audio input from the user that is louder than a predetermined audio intensity threshold, which predetermined range and predetermined audio intensity threshold are each maintained by at least one memory device 204 and/or preconfigured into eye detector 112. In some embodiments of the present invention, when the user's eye is detected within the predetermined range of mobile device 110, then the presence of an audio signal above the predetermined audio intensity threshold is interpreted by processor 202 as a PTT-enabling event that triggers an enablement of PTT functionality in the same way as would the physical actuation of a PTT button or key.

Mobile device 110 preferably is a Public Safety (PS) device that communicates with a serving access network via a Public Safety Narrowband (PSNB) spectrum. However, mobile device 110 may any type of wireless user device, such as a personal device (for example, a cellular telephone) that communicates with a serving access network via a wireless network technology such as Code Division Multiple Access 2000 (CDMA 2000), Universal Mobile Telecommunication System (UMTS), Frequency Division Multiple Access (FDMA), Time Division Multiple Access (TDMA), Long Term Evolution (LTE), Wireless Local Area Network (WLAN) as described by the IEEE 802.xx standards, for example, the 802.11, 802.15, 802.16, or 802.20 standards, or Orthogonal Frequency Division Multiple Access (OFDM).

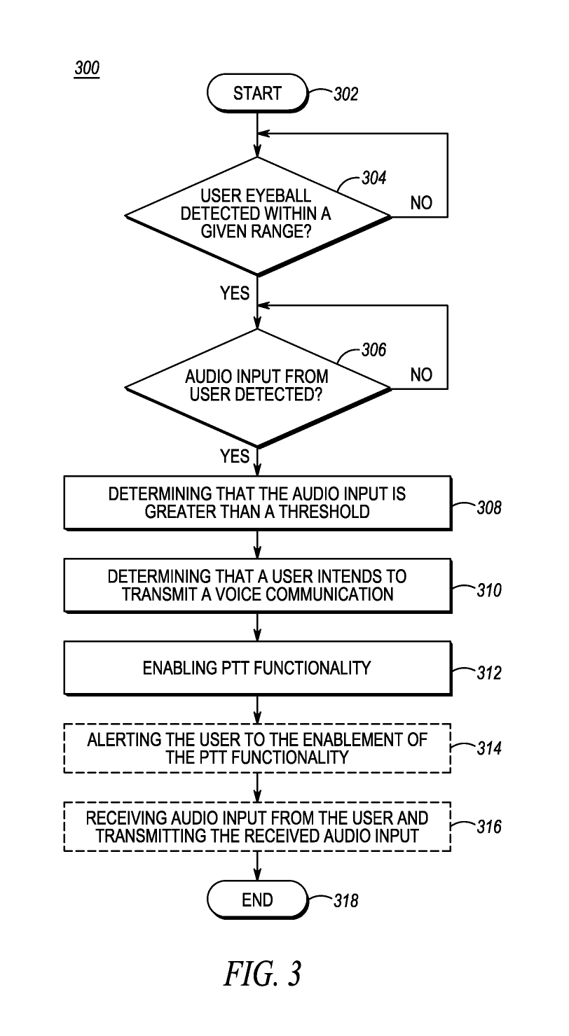

Referring now to FIG. 3, a logic flow diagram 300 is provided of a method of PTT functionality enablement that is performed by mobile device 110 in accordance with some embodiments of the present invention. Logic flow diagram 300 begins (302) when mobile device 110, and in particular eye detector 112, detects (304) the presence of eye 104 of user 102. Additionally, mobile device 110, and in particular audio input circuitry 230, detects (306) an audio input of the user and determines (308) that the audio input of the user that is greater than the audio intensity threshold maintained by at least one memory device 204. In response to detecting the presence of eye 104 and determining the audio input that is greater than the audio intensity threshold, mobile device 110 determines (310) that user 102 intends to transmit a voice communication using mobile device 110 and enables (312) PTT functionality of the mobile device, that is, enables a voice transmission by user 102 as part of a PTT communication session. Logic flow diagram 300 then ends (318).

In some embodiments of the present invention, detecting eye 104 of user 102 may comprise determining, by mobile device 110, a direction of focus of eye 104 and, based on the determined direction of focus, determining that user 102 is looking at the mobile device. Further, in some embodiments of the of the present invention, detecting the presence of eye 104 of user 102 may instead, or in addition, comprise determining, by processor 202, that the eye of the user is within a predetermined range, that is, a predetermined set of distances, of mobile device 110. That is, a camera of eye detector 112 may have a preset focal range that is preset to a predetermined range, or set of distances, for example, zero (0) to 12 inches. When user 102 is within the preset focal range of eye detector 112, then the eye detector will be able to detect eye 104 of user 102. However, if user 102 is outside of the preset focal range, then eye detector 112 will not be able to detect the user's eye. Thus, mobile device 110 will determine that user 102 intends to transmit a voice communication using mobile device, and automatically trigger the PTT functionality, only when the user is within the preset focal range of eye detector 112.

Additionally, in some embodiments of the present invention, detecting an audio input greater than an audio intensity threshold may include determining that the audio input comprises the voice of the user. For example, at least one memory device 204 may store voice patterns associated with user 102. Mobile device 110, and in particular processor 202, then may associate user 102 with an audio input received from the user by matching a voice pattern determined for the audio input to the stored voice pattern in accordance with known voice recognition techniques.

Also, in some embodiments of the present invention, the audio intensity threshold may comprise a volume differential threshold. In such embodiments, detecting an audio input greater than an audio intensity threshold may include determining a volume level of an audio signal received from user 102 and determining a volume level of background noise. Mobile device 110, and in particular processor 202, then may determine a volume differential between the volume level of the received audio signal and the volume level of the background noise, compare this volume differential to the volume differential threshold maintained by at least one memory device 204, and when the determined volume differential is greater than the volume differential threshold, enable PTT functionality. In other embodiments of the present invention, the audio intensity threshold may comprise a ratio threshold. In such embodiments, instead of determining a volume differential between the volume levels of the received audio signal and the background noise, mobile device 110, and in particular processor 202, may determine a ratio of the volume level of an audio signal received from user 102 to the volume level of background noise, compare this ratio to the ratio threshold maintained by at least one memory device 204, and when the determined ratio is greater than the ratio threshold, enable PTT functionality.

In some embodiments of the present invention, in response to enabling the PTT functionality of mobile device 110, the mobile device may alert (314) user 102 that the PTT functionality has been enabled, for example, by providing an audio, visual, or tactile alert. For example, PTT indicator 114 may be a light emitting diode (LED) that is illuminated by mobile device 110 when the PTT functionality has been enabled. By way of another example, mobile device 110 may emit an audio tone, for example, via speaker 226 or via PTT indicator 114 in the event the PTT indicator is a speaker, indicating that the PTT functionality has been enabled. By way of yet other examples, mobile device 110 may provide an indication on display screen 118, for example, a textual indication, that the PTT functionality has been enabled or may provide a tactile indication indicating that the PTT functionality has been enabled, for example, by causing a vibration of mobile device 110.

Further, in some embodiments of the present invention, in response to enabling the PTT functionality of mobile device 110, the mobile device may receive (316), via microphone 116, audio input from the user 102 intended for transmission to other mobile devices and then transmit, via wireless network interface 216 and either directly or indirectly to the other mobile devices, for example, via the access network serving mobile device 110, the received audio input that is intended for transmission to the other mobile devices.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. Furthermore, unless otherwise indicated herein, the use of relational terms, if any, such as first, second, third, and fourth, and the like are used solely to distinguish one entity or action, such as one frame, metric, or time period, from another entity or action without necessarily requiring or implying any actual such relationship or order between such entities or actions.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for enabling Push-to-Talk (PTT) functionality, the method comprising:
detecting a presence of an eye of a user;
detecting an audio input from the user;
determining that the audio input is greater than an audio intensity threshold; and
in response to detecting the presence of the eye of the user and detecting the audio input greater than the audio intensity threshold, enabling PTT functionality.

2. The method of claim 1, wherein determining that the audio input is greater than the audio intensity threshold comprises:
determining that the audio input comprises a voice of the user.

3. The method of claim 1, wherein the audio intensity threshold comprises a volume differential threshold and wherein determining that the audio input is greater than the audio intensity threshold comprises:
determining a volume level of a received audio signal;
determining a noise level;
determining a volume differential between the volume level of the received audio signal and the noise level; and
wherein enabling PTT functionality comprises enabling PTT functionality when the volume differential between the volume level of the received audio signal and the noise level is greater than the volume differential threshold.

4. The method of claim 1, wherein the audio intensity threshold comprises a ratio threshold and wherein determining that the audio input is greater than the audio intensity threshold comprises:
determining a volume level of a received audio signal;
determining a noise level;
determining a ratio of the volume level of the received audio signal to the noise level; and
wherein enabling PTT functionality comprises enabling PTT functionality when the ratio of the volume level of the received audio signal to the noise level is greater than the ratio threshold.

5. The method of claim 1, wherein detecting the presence of the eye of the user comprises determining that the user is looking at the mobile device.

6. The method of claim 1, wherein detecting the presence of the eye of the user comprises detecting that the eye of the user is within a predetermined range of the mobile device.

7. The method of claim 1, wherein enabling PTT functionality comprises alerting the user that the PTT functionality has been enabled.

8. The method of claim 1, wherein enabling PTT functionality comprises:
receiving audio input from the user intended for transmission to other mobile devices; and
transmitting the audio input intended for transmission to the other mobile devices.

9. A mobile device comprising:
an eye detector;
a microphone;
a processor; and
an at least one memory device that is configured to store a set of instruction that, when executed by the processor, cause the processor to:
determine, via the eye detector, a presence of an eye of a user;
detect, via the microphone, an audio input from the user;
determine that the audio input is greater than an audio intensity threshold; and
in response to determining the presence of the eye of the user and determining that the audio input is greater than the audio intensity threshold, enable PTT functionality.

10. The mobile device of claim 9, wherein the at least one memory device is configured to store a set of instruction that, when executed by the processor, cause the processor to determine that the audio input greater than an audio intensity threshold by:
determining that the audio input comprises a voice of the user.

11. The mobile device of claim 9, wherein the audio intensity threshold comprises a volume differential threshold and further wherein the at least one memory device is configured to store a set of instruction that, when executed by the processor, cause the processor to determine that the audio input is greater than the audio intensity threshold by:
determining a volume level of the audio input from the user;
determining a noise level;
determining a volume differential between the volume level of the audio input and the noise level; and
wherein enabling PTT functionality comprises enabling PTT functionality when the volume differential between the volume level of the received audio signal and the noise level is greater than the volume differential threshold.

12. The mobile device of claim 9, wherein the audio intensity threshold comprises a ratio threshold and further wherein the at least one memory device is configured to store a set of instruction that, when executed by the processor, cause the processor to determine that the audio input is greater than the audio intensity threshold by:
determining a volume level of the audio input from the user;
determining a noise level;
determining a ratio of the volume level of the audio input to the noise level; and
wherein enabling PTT functionality comprises enabling PTT functionality when the ratio of the volume level of the received audio signal to the noise level is greater than a ratio threshold.

13. The mobile device of claim 9, wherein the at least one memory device is configured to store a set of instruction that, when executed by the processor, cause the processor to detect the presence of the eye of the user by determining that the user is looking at the mobile device.

14. The mobile device of claim 9, wherein the at least one memory device is configured to store a set of instruction that, when executed by the processor, cause the processor to detect the presence of the eye of the user by detecting that the eye of the user is within a predetermined range of the mobile device.

15. The mobile device of claim 9, wherein the at least one memory device is configured to store a set of instruction that, when executed by the processor, cause the processor to enable PTT functionality by alerting the user that the PTT functionality has been enabled.

16. The mobile device of claim 9, wherein the at least one memory device is configured to store a set of instruction that, when executed by the processor, cause the processor to enable PTT functionality by:
receiving audio input from the user intended for transmission to other mobile devices; and
transmitting the audio input intended for transmission to the other mobile devices.
